(19) United States
(12) Patent Application Publication
(10) Pub. No.: US 2011/0143786 A1
(43) Pub. Date: Jun. 16, 2011

(54) System and Method for Restricting Text Messaging

(76) Inventors: James FAN, San Ramon, CA (US); Thomas BARRETT, San Ramon, CA (US); Jennifer LAM, Fremont, CA (US)

(21) Appl. No.: 12/638,240

(22) Filed: Dec. 15, 2009

(51) Int. Cl. H04W 4/12; H04B 1/06

(52) U.S. Cl. 455/466; 455/26.1

(57) ABSTRACT

A system for restricting a functionality of a wireless device includes the wireless device and a movement sensor. The movement sensor determines a speed at which the wireless device is moving. The movement sensor transmits a signal when the speed is greater than a predetermined threshold. The signal is at least partially a basis to restrict the functionality, wherein the restriction does not completely disable the functionality.

### BACKGROUND

A wireless device such as a mobile phone may be equipped with various features. One feature may be text messaging. A text messaging feature enables a user to type in a message for transmission to another device to be read. However, much like the use of the mobile phone while driving, text messaging while driving has become one of the major distractive behaviors to cause motor vehicle accidents. As of the year 2009, fourteen states and Washington D.C. have passed a law to ban text messaging while driving.

### SUMMARY OF THE INVENTION

The exemplary embodiments describe a system for restricting a functionality of a wireless device includes the wireless device and a movement sensor. The movement sensor determines a speed at which the wireless device is moving. The movement sensor transmits a signal when the speed is greater than a predetermined threshold. The signal is at least partially a basis to restrict the functionality, wherein the restriction does not completely disable the functionality.

### DESCRIPTION OF THE DRAWINGS

FIG. 1 shows a wireless device according to an exemplary embodiment.

FIG. 2 shows a distance detector according to an exemplary embodiment.

FIG. 3 shows a method for restricting a text messaging feature according to an exemplary embodiment.

### DETAILED DESCRIPTION

The exemplary embodiments may be further understood with reference to the following description and the appended drawings, wherein like elements are referred to with the same reference numerals. The exemplary embodiments describe a system and method for restricting a text messaging feature on a wireless device. Specifically, the text messaging feature is restricted when a movement is detected such as when the wireless device of a driver is located in a vehicle. The text messaging feature, the wireless device, the restriction, the movement detection, and a related method will be discussed in further detail below.

It should be noted that the following describes the system and method of the exemplary embodiments with respect to a text messaging feature. However, the text messaging feature is used as an exemplary functionality of a wireless device in which the system and method of the exemplary embodiments cover. Thus, the text messaging feature may further exemplify any functionality of the wireless device that may be restricted.

It should also be noted that the following describes the system and method of the exemplary embodiments with respect to a moving vehicle. However, the restriction of the text messaging feature may be performed in other locations. For example, the text messaging feature may be restricted in an office or school.

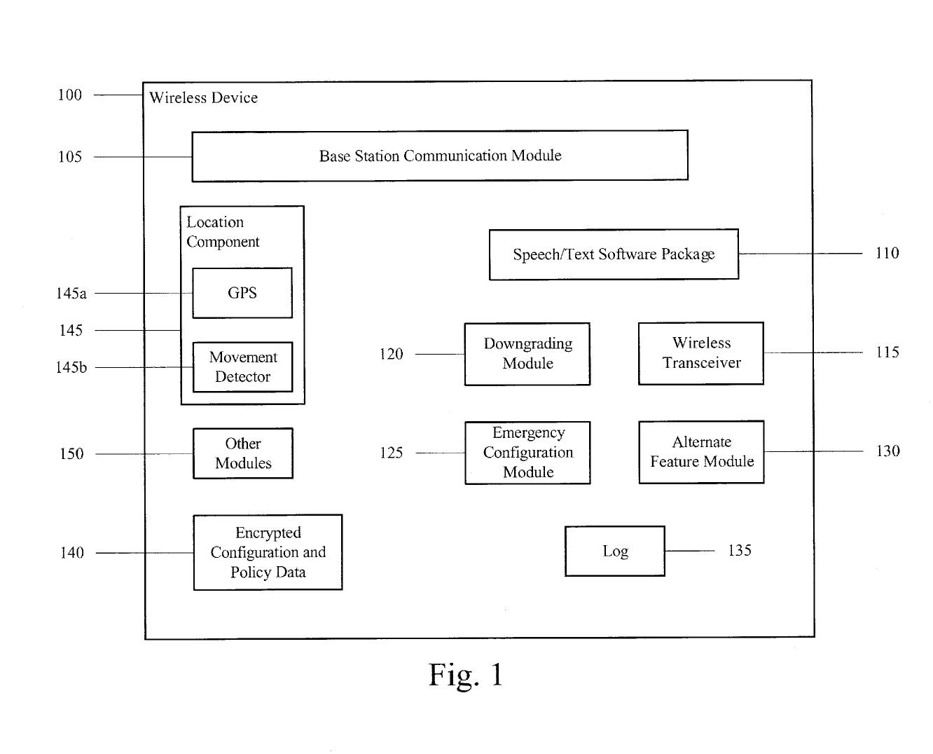

FIG. 1 shows a wireless device 100 according to an exemplary embodiment. The wireless device 100 may be, for example, a mobile phone. The wireless device 100 may include a variety of functionalities such as a telephone capability, a text messaging functionality, an address book feature, etc. The wireless device 100 may include a base station communication module 105, a speech/text software package 110, a wireless transceiver 115, a downgrading module 120, an emergency configuration module 125, an alternate feature module 130, a log 135, an encrypted configuration and policy data 140, a location component 145, and other modules 150.

The base station communication module 105 may be a component to enable the wireless device 100 to communicate with a base station. For example, when the wireless device 100 is a mobile phone, the base station communication module 105 may be a cell phone radio communication module used to communicate with a 2.5/3G wireless base station of a cellular network that provides cellular service to the mobile phone.

The speech/text software package 110 may enable the wireless device 100 to convert a text message to a speech message or convert a speech message to a text message. As discussed above, the wireless device 100 may be equipped with the text messaging feature. When a text message is received by the wireless device 100, the speech/text software package 110 may convert the data into an audio message to be played. In relation to a driver of a moving vehicle, an audio message may provide less of a distraction to the user of the wireless device 100. Furthermore, the speech/text software package 110 may convert audio data received from the user and convert the speech to text to send a text message without requiring a need to key in the message. Likewise, in relation to a driver of a moving vehicle, a speech conversion may provide less of a distraction to the user of the wireless device 100.

The wireless transceiver 115 may be a chipset and associated firmware of the wireless device 100 that enables a receiving of a signal to restrict the text messaging feature from a cell phone detection sensor. The wireless transceiver 115 may operate in any known wireless communication protocol such as Bluetooth, Zigbee, etc. As will be described in further detail below, the restriction of the text messaging feature of the wireless device 100 may work in conjunction with the cell phone detection sensor.

The downgrading module 120 may be a component of the wireless device 100 that restricts the text messaging feature. When the downgrading module 120 receives an indication that the wireless device 100 is in a moving vehicle, the downgrading module 120 may initiate a restriction protocol that limits the uses of the text messaging feature. As will be discussed in further detail below, the downgrading module 120 may either enable the speech/text option provided by the speech/text software package 110 or disable the text messaging feature entirely.

The emergency configuration module 125 may be a component of the wireless device 100 that is used when the text messaging feature is restricted. As discussed above, the downgrading module 120 may allow the text messaging feature to be disabled. However, although disabled, the text messaging feature may still be configured to allow select types of text messages to be sent such as for emergency communications. The emergency configuration module 125 may configure soft keys (e.g., touch pad), hard keys (e.g., key pad), or a combination thereof to allow an easy way to send an emergency text message when the text messaging feature is disabled.

The alternate feature module 130 may be a component of the wireless device 100 that enables an override of the downgrading module 120. As discussed above, the emergency configuration module 125 may also override the downgrading module 120 to allow emergency text messages to be sent. The alternate feature module 130 may also enable other types of text messages or other types of downgrading options. For example, the emergency configuration module 125 may enable contacting emergency services such as the police or an EMT via text messaging when the text messaging feature has been disabled. The alternate feature module 130 may enable other emergency contacts to be reached when the text messaging feature has been disabled. In another example, the emergency configuration module 125 may enable an override of the downgrading module 120 entirely. For example, if the wireless device 100 is for a user that is part of the emergency services (e.g., police officer, fireman, EMT, etc.), the downgrading of text messaging may be overridden for these authorized users.

The log 135 and the encrypted configuration and policy data 140 may be a data store of the wireless device 100. The log 135 may store all changes and audit trails relating to a downgrading of the text messaging feature. The data may include, for example, all text messaging state change requests, actual state change frequencies, etc. The encrypted configuration and policy data 140 may include text messaging policies and current configuration information relating to the wireless device 100. For example, the downgrading module 120 may include a functionality for a remote downgrading by a non-user of the wireless device 100. The encrypted configuration and policy data 140 may include the protocol for a remote disabling.

The location component 145 may include a global positioning system (GPS) chipset 145a and a movement detector 145b. The GPS 145a may be an optional module that allows a GPS system to measure a speed of movement relative to the wireless device 100. Using conventional movement determining algorithms, the GPS 145a may provide location data and corresponding time intervals for the speed to be determined. The movement detector 145b may detect movement of the wireless device 100 and further calculate a relative speed of the wireless device 100. The movement detector 145b may be any conventional speed determining device such as an accelerometer.

The above exemplary components of the wireless device 100 may be part of the restricting of the text messaging feature. However, the wireless device 100 may include further modules for respective functionalities that the wireless device 100 may provide. Thus, the other modules 150 may represent exemplary modules that provide the further functionalities.

According to the exemplary embodiments, the wireless device 100 may include the necessary components to determine whether the text messaging feature is to be restricted. As discussed above, the wireless device 100 may include the location component 145 that may determine a speed at which the wireless device 100 is moving. The speed may be a determining factor that indicates if the text messaging feature is to be restricted. The encrypted configuration and policy data 140 may include a threshold speed at which the downgrading module 120 initiates a protocol to restrict the text messaging feature.

The restricting protocol may include an initial alert to be displayed. The alert may indicate that the text messaging feature will be restricted in a predetermined time period (e.g., 10 seconds, 30 seconds, 1 minute, etc.). The alert may be visual, audio, or a combination thereof. Along with the alert may be a prompt to select a type of restriction for the text messaging feature. A first type of restriction may be to disable the text messaging feature of the wireless device 100. A second type of restriction may be for a speech/text option only in which a keypad entry for a message is disabled. A default option may be automatically chosen if a selection is not made during the predetermined time period. For example, the default option may be to restrict the text messaging feature to the emergency mode.

In either instance (i.e., disabled or speech/text), the emergency configuration module 125 may allow emergency text messages to be sent. As discussed above, soft keys or hard keys may be preconfigured for the emergency text messages. When the text messaging feature is disabled or the speech/text option is enabled (i.e., keypad entry is no longer viable), the preconfigured keys may become activated. If the emergency mode text messages are used, geo-coordinates may also automatically be sent. The location component 145 may be used to determine the geo-coordinates.

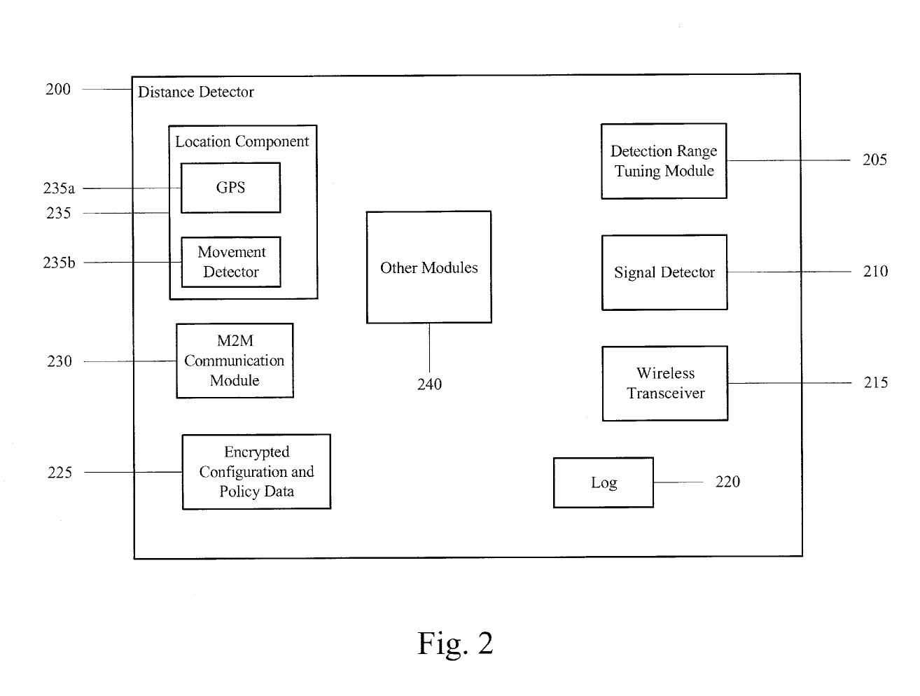

FIG. 2 shows a distance detector 200 according to an exemplary embodiment. The distance detector 200 may be a device installed in a variety of locations. According to the exemplary embodiments in which the text messaging functionality is restricted as a function of speed, the distance detector 200 may be disposed in a vehicle such as an automobile. The distance detector 200 may include a detection range running module 205, a signal detector 210, a wireless transceiver 215, a log 220, an encrypted configuration and policy data 225, a communication module 230, a location component 235, and other modules 240.

The detection range tuning module 205 may be configured to set a range in which the distance detector 200 performs the restricting of the text messaging feature. The detection range tuning module 205 may be equipped with an input device such as a keypad to set a range to detect wireless deices.

The signal detector 210 may be a component that detects all wireless devices within the range set by the detection range tuning module 205. Using any range detecting method such as infrared (IR), radio frequency identification (RFID), etc., the signal detector 210 may detect a presence of a wireless device or multiple wireless devices from the distance detector 200.

The wireless transceiver 215 may be a chipset and associated firmware for the distance detector 200. The wireless transceiver 215 may transmit signals to wireless devices in range. As will be discussed in detail below, when a speed associated with the wireless device passes a predetermined threshold, the wireless transceiver 215 may receive a signal from the signal detector 210 of a wireless device to transmit a signal to the wireless device to prompt a warning message indicating that the text messaging feature will be restricted.

The log 220 and the encrypted configuration and policy data 225 may be substantially similar to the log 135 and the encrypted configuration and policy data 140 of the wireless device 100. Thus, the log 220 and the encrypted configuration and policy data 225 may include all detection history and range change history and contain range detection policies and current configuration information for the distance detector, respectively.

The communication module 230 may be a component of the distance detector 200 that enables the distance detector 200 to send logs or alerts to a remote device. As discussed above, the exemplary embodiments may enable a remote device to restrict the text messaging feature. The communication module 230 may send a signal to the remote device indicating that the detected wireless device via the signal detector 210 has surpassed the predetermined threshold and may further prompt to restrict the text messaging feature.

The location component 235 may be substantially similar to the location component 145 of the wireless device 100. The location component 235 may also include a GPS 235a and a movement detector 235b. Similar to the wireless device 100, the distance detector 200 may also include further modules for respective functionalities that the distance detector 200 may provide. Thus, the other modules 240 may represent exemplary modules that provide the further functionalities.

As discussed above, the wireless device 100 may function individually or may work in conjunction with the distance detector 200 to restrict the text messaging feature. When functioning individually, the wireless device 100 may operate according to the above description with respect to FIG. 1. When operating in conjunction with the distance detector 200, the wireless transceiver 215 of the distance detector 200 may transmit a signal to the wireless device 100. As discussed above, the wireless device 100 may include the wireless transceiver 115 that receives the signal.

According to the exemplary embodiments, the distance detector 200 may be preinstalled into a vehicle or may be manually installed if the text messaging feature restriction is desired. The distance detector 200 may be installed at a variety of locations. However, since the text messaging feature is to be restricted for a driver of the vehicle, the distance detector 200 is preferably installed on a steering wheel, on a dash board, on a driver's side door, on a radio board, etc.

Those skilled in the art will understand that the signal detector 210 may receive signals from a wireless device that is activated. If a wireless device or all communication modules of the wireless device is deactivated, the signal detector 210 would not receive any signals therefrom. Thus, when the signal detector 210 determines that there is at least one wireless device in the predetermined range set by the detection range running module 205 and the location component 235 determines that the wireless device is in a state of movement that surpasses the predetermined threshold stored in the encrypted configuration and policy data 225, the wireless transceiver 215 may send a signal to the wireless device.

In a substantially similar manner as when the wireless device 100 solely restricts the text messaging feature, the signal received by the wireless device from the wireless transceiver 215, an alert may be displayed indicating that the text messaging feature will be restricted in a predetermined time period. With the alert, a prompt may be displayed indicating a selection is to be made whether the text messaging feature is to be restricted or disabled.

If the text messaging feature is disabled, the text messaging feature is no longer active. If the text messaging feature is restricted, the speech/text option may be activated. Again, whether the text messaging feature is disabled/restricted, the emergency mode text messages may still be active for use.

It should be noted that the distance detector 200 may only affect those wireless devices that are within the range of the signal detector 210 that is set by the detection range tuning module 205. If a wireless device is disposed outside the set range, a signal is not received by the transceiver of the wireless device for the subsequent steps to be executed for restricting the text messaging feature.

The text messaging feature may be restricted using a variety of standardizations. For example, the restriction may be part of a subscription basis. Thus, if a user of the wireless device is a subscribed user, then the above methods may be executed to restrict the text messaging feature. In another example, a global standardization may be used where all wireless devices are configured to restrict the text message feature given predetermined parameters. The subscription basis or the global standardization may enable the remote restriction capability as well. In either instance, the service provider may be contacted by a user of a third device to be notified and/or have control to restrict the text messaging feature.

It should be noted that the distance detector 200 may be used for other locations. For example, in a court room, mobile device use may be strictly prohibited. Thus, neither telephone capabilities nor text messaging may be allowed. The distance detector 200 may be configured to merely detect wireless devices in a given range (e.g., a size of the court room). When an activated wireless device is detected, the alert and prompt may be transmitted via the wireless transceiver 215 which restricts the text messaging feature.

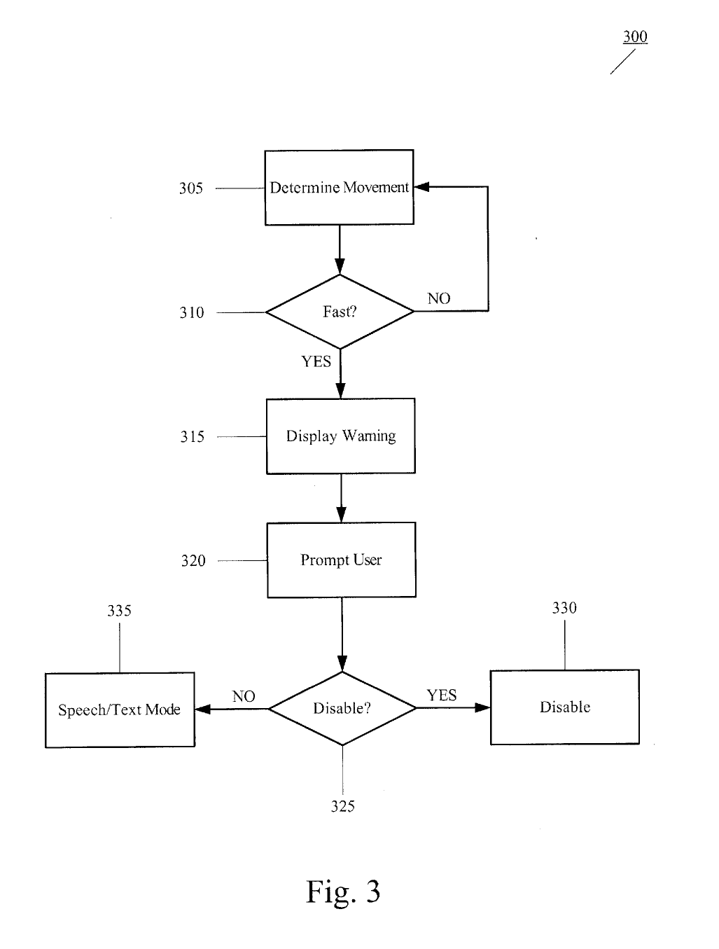

FIG. 3 shows a method 300 for restricting a text messaging feature according to an exemplary embodiment. The method 300 may apply to when the wireless device is solely configured to restrict the text messaging feature or when the wireless device works in conjunction with the distance detector to restrict the text messaging feature. The method 300 will be described with reference to the wireless device 100 of FIG. 1 and the distance detector 200 of FIG. 2.

In step 305, a movement is detected. In the case where the wireless device 100 determines the speed solely, the location component 145 may detect the movement. In the case where the distance detector 200 is used, the location component 235 may detect the movement. It should be noted that the wireless device 100 may be equipped with the components of FIG. 1 in addition to the distance detector 200 being used. In such an exemplary embodiment, both location component 145 and the location component 235 may be used to determine the speed.

In step 310, a determination is made by the location component 145 and/or 235 whether the detected movement and corresponding speed is beyond a predetermined threshold. As discussed above, the encrypted configuration and policy data 140 and/or 225 may include the predetermined threshold to determine if the wireless device is in a moving vehicle. If the speed is not beyond the predetermined threshold, the method 300 returns to step 310 where the movement is continually determined.

If the speed is beyond the predetermined threshold, the method 300 continues to step 315 where the alert is displayed on the wireless device 100. In the exemplary embodiment where the wireless device 100 is solely capable of restricting the text messaging service, the alert may be displayed using appropriate modules of the wireless device 100. In the exemplary embodiment where the distance detector 200 is used, the alert may be generated by initially transmitting a signal from the wireless transceiver 215 of the distance detector 200 to the wireless transceiver 115 of the wireless device 100. The signal may indicate that the alert is to be displayed.

In step 320, the prompt may also be displayed with the alert using substantially similar means as described above with reference to step 315. The prompt may further enable a user to select a restriction type for the text messaging feature. Thus, in step 325, a determination is made whether the option to disable the text messaging feature is selected. If the disable option is chosen, the method 300 continues to step 330 where the text messaging feature is disabled. If the restriction type is selected to be the speech/text mode or no option was selected, the method 300 continues to step 335 where the speech/text mode is initiated on the wireless device 100.

As discussed above, whether the text messaging feature is restricted by disabling the feature or activated using the speech/text mode, the emergency mode for the text messaging feature may be activated to enable emergency services to be contacted.

It should be noted that further steps may be included in the method 300. For example, as discussed above, the text messaging service may be restricted by a third device. Thus, after step 310, an additional step may include transmitting (e.g., via the communication module 230) a signal to the third device to indicate that the detected wireless device 100 has surpassed the predetermined threshold. Subsequent steps may include sending an alert indicating which restriction type has been selected by the third device.

In another example, an ultimate step may be to update the log 135 and/or the log 220 of the changes that have occurred with the restricting of the text messaging service. In yet another example, a verification step may be included between steps 305 and 310 in which the encrypted configuration and policy data 140 and/or 225 is referenced to determine if subsequent steps are to be executed. For example, if the wireless device 100 is for a user of an emergency service, all subsequent steps may be bypassed as the text messaging service may never be restricted on that wireless device.

The exemplary embodiments enable a feature of a wireless device such as text messaging to be restricted. The restriction may be, for example, for a driver of a moving vehicle. Thus, the distraction caused from using the text messaging feature may be limited. The alert/prompt used with the exemplary embodiments may further enable passengers of a moving vehicle to still maintain use of the text messaging feature. The alert/prompt may enable a disablement of the text messaging feature or a restriction of the text messaging feature in which a speech/text mode is enabled, thereby disabling a keypad entry for text messages. Furthermore, an emergency mode may be enabled in which selected keys are used to contact emergency services including geo-coordinates to locate the wireless device transmitting the text message to the emergency services. In addition, the exemplary embodiments may enable a remote restriction for the text messaging feature.

It will be apparent to those skilled in the art that various modifications may be made in the present invention, without departing from the spirit or scope of the invention.

Thus, it is intended that the present invention cover the modifications and variations of this invention provided they come within the scope of the appended claims and their equivalents.

1. A system, comprising:
a wireless device including a feature; and
a movement sensor determining a speed at which the wireless device is moving, the movement sensor transmitting a signal when the speed is greater than a predetermined threshold, the signal being at least partially a basis to restrict the feature, wherein the restriction does not completely disable the feature, wherein the feature is a text messaging feature and the restriction is a conversion of the text messaging feature to a speech/text mode.

2. (canceled)

3. The system of claim 1, wherein the movement sensor is disposed with the wireless device.

4. The system of claim 1, wherein the signal is received by a first wireless transceiver of the wireless device that is transmitted from a second wireless transceiver of the movement sensor.

5. The system of claim 4, wherein the movement sensor further comprises a signal detector to determine a presence of the wireless device, the signal detector having a preset range in which to detect the wireless device.

6. The system of claim 1, further comprising:
a downgrading module receiving the signal to initiate the restriction.

7. The system of claim 1, wherein the speech/text mode converts incoming text messages to an audio message to be played for a user and converts speech of the user to an outgoing text message.

8. The system of claim 1, wherein the restriction further activates an emergency mode of the feature.

9. The system of claim 1, wherein the movement sensor further comprises a communications module to exchange signals with a remote device, the remote device being configured to receive the signal to generate a further signal received by the wireless device indicating the feature to be restricted.

10. A method, comprising:
determining, by a movement sensor, a speed at which a wireless device is moving, the wireless device including a feature;
transmitting a signal when the speed is greater than a predetermined threshold; and
restricting the feature using the signal as at least a partial basis, wherein the restriction does not completely disable the feature, wherein the feature is a text messaging feature and the restriction is a conversion of the text messaging feature to a speech/text mode.

11. (canceled)

12. The method of claim 10, wherein the movement sensor is disposed with the wireless device.

13. The method of claim 10, further comprising:
transmitting the signal by a first wireless transceiver of the movement sensor; and
receiving the signal by a second wireless transceiver of the wireless device.

14. The method of claim 13, further comprising:
determining a presence of the wireless device by a signal detector of the movement sensor, the signal detector having a preset range in which to detect the wireless device.

15. The method of claim 10, further comprising:
initiating the restriction upon a downgrading module receiving the signal.

16. The method of claim 10, wherein the speech/text mode converts incoming text messages to an audio message to be played for a user and converts speech of the user to an outgoing text message.

17. The method of claim 10, wherein the restriction further activates an emergency mode of the feature.

18. A system, comprising:
a wireless device including a feature; and
a speed determining means for determining a speed at which the wireless device is moving, the speed determining means transmitting a signal when the speed is greater than a predetermined threshold, the signal being at least partially a basis to restrict the feature, wherein the restriction does not completely disable the feature wherein the feature is a text messaging feature and the restriction is a conversion of the text messaging feature to a speech/text mode.

19. The system of claim 1, wherein the wireless device provides a prompt to a user when the restriction is implemented.

20. The system of claim 19, wherein the wireless device is configured to receive input from the user in response to the prompt to completely disable the feature.

21. The method of claim 10, further comprising:
providing a prompt to a user when the restriction is implemented.

22. The method of claim 21, further comprising:
receiving input from the user in response to the prompt; and
completely disabling the feature in response to the input.
